(19) United States
(12) Patent Application Publication
(10) Pub. No.: US 2024/0223295 A1
(43) Pub. Date: Jul. 4, 2024

(54) OPTICAL COMMUNICATION DEVICE, SIGNAL PROCESSING DEVICE, OPTICAL COMMUNICATION METHOD, AND SIGNAL PROCESSING METHOD

(71) Applicant: NIPPON TELEGRAPH AND TELEPHONE CORPORATION, Tokyo (JP)

(72) Inventors: Kota ASAKA, Musashino-shi, Tokyo (JP); Keita NISHIMOTO, Musashino-shi, Tokyo (JP); Hiroshi O, Musashino-shi, Tokyo (JP)

(73) Assignee: NIPPON TELEGRAPH AND TELEPHONE CORPORATION, Tokyo (JP)

(21) Appl. No.: 18/563,379

(22) PCT Filed: May 26, 2021
(86) PCT No.: PCT/JP2021/020039

§ 371 Date: Nov. 22, 2023

(51) Int. Cl. H04J 3/06; H04B 10/27

(52) U.S. Cl. CPC H04J 3/0661; H04B 10/27

(57) ABSTRACT

An optical communication device connected to an optical path in an optical communication network includes a controller. The controller generates an additional information signal having a carrier frequency different from a carrier frequency of a main optical signal. The controller generates an output optical signal by superimposing the additional information signal on the main optical signal, and outputs the output optical signal to the optical path. The additional information signal includes a time stamp reflecting a timing at which the additional information signal is generated.

### TECHNICAL FIELD

The present disclosure relates to time stamp processing using an optical signal in an optical communication network.

### BACKGROUND ART

As one of methods for measuring a signal transmission delay in a communication network, active measurement is known that measures a signal transmission delay by inserting a probe packet into a communication network.

Non Patent Literature 1 proposes a “pass through delay measurement method” in which a time stamp is added to a probe packet for each measurement point. FIG. 1 is a conceptual diagram for explaining the pass through delay measurement method disclosed in Non Patent Literature 1. A probe transmission unit A sends out a probe packet (for example, a UDP packet) to a probe reception unit B. In a communication path between the probe transmission unit A and the probe reception unit B, time stamp units C-1, C-2, and C-3 and communication devices D-1 and D-2 are provided. Synchronized high-precision clocks are connected to the time stamp units C-1, C-2, and C-3, respectively, and high-precision time information is provided. Each of the time stamp units C-1, C-2, and C-3 adds a pass through time of the probe packet as a time stamp to the end of the probe packet. The probe packet received by the probe reception unit B includes time stamps added to the respective time stamp units C-1, C-2, and C-3. A delay time (total of processing delay, queuing delay, and serialization delay) generated in each of the communication devices D-1 and D-2 can be measured on the basis of a corresponding one of the time stamps.

### CITATION LIST

### Non Patent Literature

Non Patent Literature 1: Nakagawa et al., “Development of a high-precision time server,” Information Processing, Vol. 49, No. 10, pp. 1184-1191, 2008.

### SUMMARY OF INVENTION

### Technical Problem

According to the above-described delay measurement method, a probe packet for delay measurement is transmitted separately from a main signal. An overhead due to the probe packet causes an increase in a transmission delay of the main signal and a decrease in a transmission capacity of the main signal.

One object of the present disclosure is to provide a technique capable of suppressing the increase in the transmission delay of the main signal and the decrease in the transmission capacity of the main signal when a time stamp is used in a communication network.

### Solution to Problem

A first viewpoint relates to an optical communication device connected to an optical path in an optical communication network.

The optical communication device includes a controller.

The controller is configured to: generate an additional information signal having a carrier frequency different from a carrier frequency of a main optical signal; generate an output optical signal by superimposing the additional information signal on the main optical signal; and output the output optical signal to the optical path.

The additional information signal includes a time stamp reflecting a timing at which the additional information signal is generated.

A second viewpoint relates to a signal processing device connected to an optical communication device via an optical path in an optical communication network.

The optical communication device is configured to: generate an additional information signal having a carrier frequency different from a carrier frequency of a main optical signal; generate an output optical signal by superimposing the additional information signal on the main optical signal; and output the output optical signal to the optical path.

The additional information signal includes a time stamp reflecting a timing at which the additional information signal is generated.

The signal processing device includes a controller.

The controller is configured to: receive the output optical signal output from the optical communication device via the optical path; extract the additional information signal from the output optical signal received; and store, in a storage device, the time stamp included in the additional information signal and an arrival time stamp reflecting a timing at which the additional information signal arrives at the signal processing device.

A third viewpoint relates to an optical communication method by an optical communication device connected to an optical path in an optical communication network.

The optical communication method includes: a process of generating an additional information signal having a carrier frequency different from a carrier frequency of a main optical signal; a process of generating an output optical signal by superimposing the additional information signal on the main optical signal; and a process of outputting the output optical signal to the optical path.

The additional information signal includes a time stamp reflecting a timing at which the additional information signal is generated.

A fourth viewpoint relates to a signal processing method by a signal processing device connected to an optical communication device via an optical path in an optical communication network.

The optical communication device is configured to: generate an additional information signal having a carrier frequency different from a carrier frequency of a main optical signal; generate an output optical signal by superimposing the additional information signal on the main optical signal; and output the output optical signal to the optical path.

The additional information signal includes a time stamp reflecting a timing at which the additional information signal is generated.

The signal processing method includes: a process of receiving the output optical signal output from the optical communication device via the optical path; a process of extracting the additional information signal from the output optical signal received; and a process of storing, in a storage device, the time stamp included in the additional information signal and an arrival time stamp reflecting a timing at which the additional information signal arrives at the signal processing device.

### Advantageous Effects of Invention

According to the present disclosure, an additional information signal having a carrier frequency different from a carrier frequency of a main optical signal is superimposed on the main optical signal. The additional information signal includes a time stamp reflecting a timing at which the additional information signal is generated. The additional information signal including the time stamp is superimposed on the main optical signal and sent out together with the main optical signal. A special signal dedicated to delay measurement is not transmitted separately from the main optical signal. Thus, it becomes possible to suppress an increase in a transmission delay of the main optical signal and a decrease in a transmission capacity of the main optical signal. By using such a time stamp, for example, it becomes possible to measure a delay time in an optical communication network.

### BRIEF DESCRIPTION OF DRAWINGS

FIG. 1 is a conceptual diagram for explaining a delay measurement method in a conventional technique.

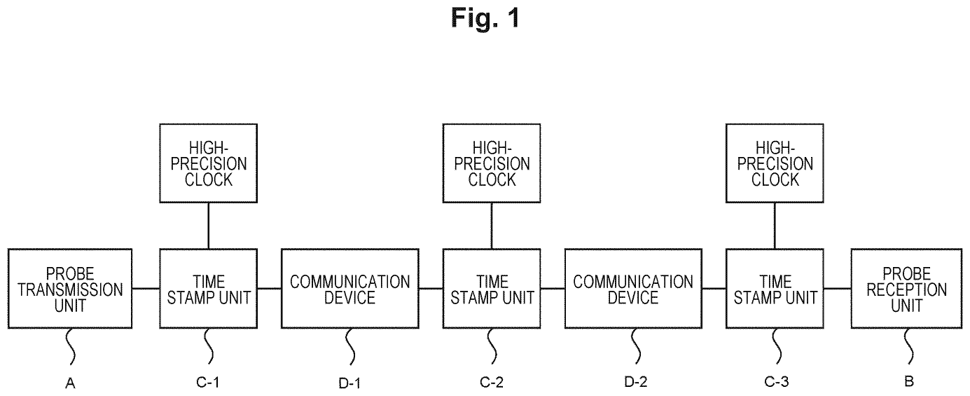

FIG. 2 is a block diagram schematically illustrating a configuration example of an optical communication system according to an embodiment of the present disclosure.

FIG. 3 is a block diagram schematically illustrating a configuration example related to delay measurement according to the embodiment of the present disclosure.

FIG. 4 is a conceptual diagram illustrating a frame configuration of an additional information signal according to the embodiment of the present disclosure.

FIG. 5 is a conceptual diagram illustrating an example of delay measurement result information according to the embodiment of the present disclosure.

FIG. 6 is a block diagram schematically illustrating a configuration example related to delay measurement based on TDM according to the embodiment of the present disclosure.

FIG. 7 is a block diagram illustrating a configuration example of a user terminal related to the delay measurement based on TDM according to the embodiment of the present disclosure.

FIG. 8 is a block diagram illustrating a first configuration example of an optical node related to the delay measurement based on TDM according to the embodiment of the present disclosure.

FIG. 9 is a block diagram illustrating a second configuration example of the optical node related to the delay measurement based on TDM according to the embodiment of the present disclosure.

FIG. 10 is a block diagram illustrating a configuration example of a signal processing device related to the delay measurement based on TDM according to the embodiment of the present disclosure.

FIG. 11 is a block diagram schematically illustrating a configuration example related to delay measurement based on FDM according to the embodiment of the present disclosure.

FIG. 12 is a block diagram illustrating a first configuration example of an optical node related to the delay measurement based on FDM according to the embodiment of the present disclosure.

FIG. 13 is a block diagram illustrating a second configuration example of the optical node related to the delay measurement based on FDM according to the embodiment of the present disclosure.

FIG. 14 is a block diagram illustrating a configuration example of a signal processing device related to the delay measurement based on FDM according to the embodiment of the present disclosure.

### DESCRIPTION OF EMBODIMENTS

An embodiment of the present disclosure will be described with reference to the accompanying drawings.

### 1. Optical Communication System

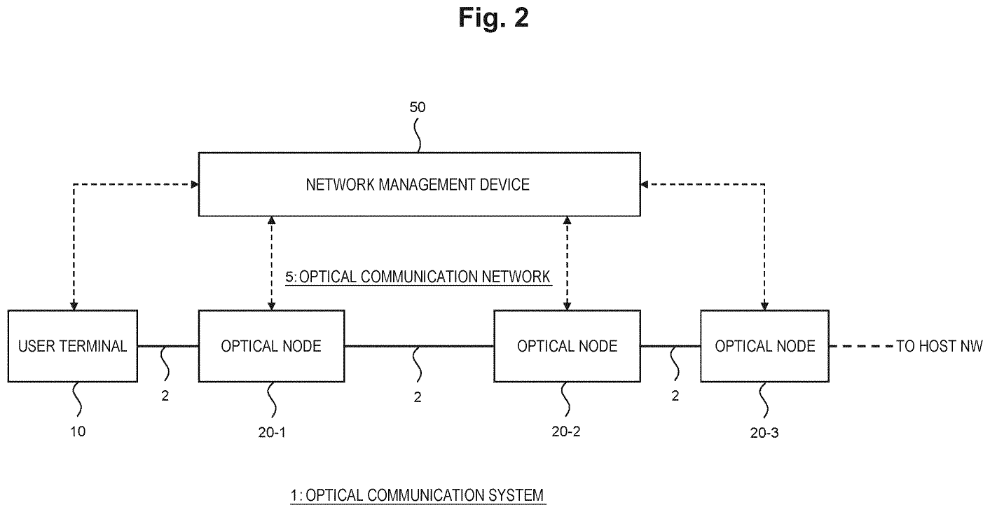

FIG. 2 is a block diagram schematically illustrating a configuration example of an optical communication system 1 according to the present embodiment. The optical communication system 1 includes a plurality of optical communication devices that performs optical communication. The plurality of optical communication devices is connected to each other via optical paths 2 (optical fibers), whereby an optical communication network 5 is formed. For example, the optical communication network 5 is an all-photonics network (APN) that performs signal transmission/transfer basically as an optical signal.

The optical communication devices include a user terminal 10 and an optical node 20. In the example illustrated in FIG. 2, the user terminal 10 and a plurality of the optical nodes 20 (20-1, 20-2, 20-3 . . . ) are connected to each other in series via the optical paths 2. The user terminal 10 is connected to a host network via the plurality of optical nodes 20.

The optical communication system 1 further includes a network management device 50 that manages the optical communication network 5. The network management device 50 is communicably connected to the user terminal 10 and each optical node 20, and manages the user terminal 10 and each optical node 20. The network management device 50 is provided, for example, in a telecommunications carrier station building.

Hereinafter, delay measurement in the optical communication network 5 according to the present embodiment will be described.

### 2. Overview of Delay Measurement

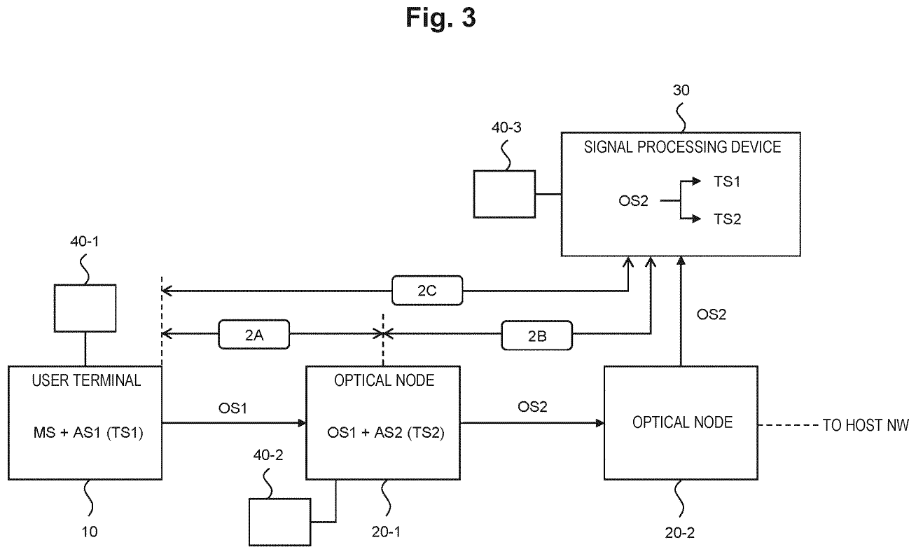

FIG. 3 is a block diagram schematically illustrating a configuration example related to the delay measurement according to the present embodiment. In addition to the above-described configuration, the optical communication system 1 further includes a signal processing device 30 for the delay measurement in the optical communication network 5. The signal processing device 30 is included in the network management device 50, for example. Alternatively, the signal processing device 30 may be provided separately from the network management device 50.

Hereinafter, as an example, the user terminal 10 (transmission device), the optical node 20-1 (relay device), and the signal processing device 30 (reception device) are considered as components for the delay measurement. The same applies to a case where the number of the optical nodes 20 is increased.

The user terminal 10 is connected to the optical node 20-1. The optical node 20-1 is connected to the signal processing device 30 via the optical node 20-2. An optical path 2A is an optical path between the user terminal 10 and the optical node 20-1. An optical path 2B is an optical path between the optical node 20-1 and the signal processing device 30 via the optical node 20-2. An optical path 2C is an optical path between the user terminal 10 and the signal processing device 30 via the optical nodes 20-1 and 20-2.

The user terminal 10, the optical node 20-1, and the signal processing device 30 are respectively connected to high-precision clocks 40-1, 40-2, and 40-3 synchronized with each other. For example, each of high-precision clocks 40 acquires time information from a network time protocol (NTP) server. The user terminal 10, the optical node 20-1, and the signal processing device 30 acquire high-precision time information from the high-precision clocks 40-1, 40-2, and 40-3, respectively.

The user terminal 10 (transmission device) transmits a main optical signal MS to the optical communication network 5. In addition, at the time of the delay measurement, the user terminal 10 generates a first additional information signal AS1 for the delay measurement. The first additional information signal AS1 includes a first time stamp TS1 reflecting a timing at which the first additional information signal AS1 is generated. The first time stamp TS1 may be the timing itself at which the first additional information signal AS1 is generated or may be in the vicinity of the timing at which the first additional information signal AS1 is generated. The first time stamp TS1 is obtained on the basis of the time information acquired from the high-precision clock 40-1. In addition, a carrier frequency of the first additional information signal AS1 is different from a carrier frequency of the main optical signal MS. Typically, the carrier frequency of the first additional information signal AS1 is sufficiently lower than the carrier frequency of the main optical signal MS. For example, an auxiliary management and control channel (AMCC) is used for the first additional information signal AS1.

As described above, the user terminal 10 generates the first additional information signal AS1 including the first time stamp TS1 and having the carrier frequency different from that of the main optical signal MS. Further, the user terminal 10 generates a first optical signal OS1 by superimposing the generated first additional information signal AS1 on the main optical signal MS (OS1=MS+AS1). Then, the user terminal 10 outputs the first optical signal OS1 (output optical signal) in which the first additional information signal AS1 is superimposed on the main optical signal MS to the optical path 2A on the optical node 20-1 side.

The optical node 20-1 (relay device) receives the first optical signal OS1 input from the optical path 2A on the user terminal 10 side. In response to the first optical signal OS1 (input optical signal) including the first additional information signal AS1, the optical node 20-1 generates a second additional information signal AS2 for the delay measurement. The second additional information signal AS2 includes a second time stamp TS2 reflecting a timing at which the second additional information signal AS2 is generated. The second time stamp TS2 may be the timing itself at which the second additional information signal AS2 is generated or may be in the vicinity of the timing at which the second additional information signal AS2 is generated. The second time stamp TS2 is obtained on the basis of the time information acquired from the high-precision clock 40-2. In addition, a carrier frequency of the second additional information signal AS2 is different from the carrier frequency of the main optical signal MS. Typically, the carrier frequency of the second additional information signal AS2 is sufficiently lower than the carrier frequency of the main optical signal MS. For example, the AMCC is used for the second additional information signal AS2.

As described above, the optical node 20-1 generates the second additional information signal AS2 including the second time stamp TS2 and having the carrier frequency different from that of the main optical signal MS. Further, the optical node 20-1 generates a second optical signal OS2 by superimposing the second additional information signal AS2 on the main optical signal MS of the first optical signal OS1 (OS2=OS1+AS2=MS+AS1+AS2). Here, as a method for multiplexing the first additional information signal AS1 and the second additional information signal AS2, time division multiplexing (TDM) or frequency division multiplexing (FDM) can be considered. The method for multiplexing the first additional information signal AS1 and the second additional information signal AS2 based on TDM or FDM will be described in detail later. Then, the optical node 20-1 outputs the second optical signal OS2 (output optical signal) in which the first additional information signal AS1 and the second additional information signal AS2 are superimposed on the main optical signal MS to the optical path 2B on the signal processing device 30 side.

The optical node 20-2 receives the second optical signal OS2 from the optical node 20-1. The optical node 20-2 causes the received second optical signal OS2 to branch and transfers the second optical signal OS2 to the host network and the signal processing device 30.

The signal processing device 30 (reception device) receives the second optical signal OS2 via the optical path 2B. The second optical signal OS2 includes the first additional information signal AS1 and the second additional information signal AS2 superimposed on the main optical signal MS. The signal processing device 30 extracts (separates) the first additional information signal AS1 and the second additional information signal AS2 from the second optical signal OS2 by using a filter. Further, the signal processing device 30 demodulates the first additional information signal AS1 to acquire the first time stamp TS1. Similarly, the signal processing device 30 demodulates the second additional information signal AS2 to acquire the second time stamp TS2.

In addition, the signal processing device 30 acquires a third time stamp TS3 (arrival time stamp) reflecting a timing at which the first additional information signal AS1 arrives at the signal processing device 30. Similarly, the signal processing device 30 acquires a fourth time stamp TS4 (arrival time stamp) reflecting a timing at which the second additional information signal AS2 arrives at the signal processing device 30. The third time stamp TS3 and the fourth time stamp TS4 are obtained on the basis of the time information acquired from the high-precision clock 40-3.

As described above, the signal processing device 30 acquires the first time stamp TS1, the second time stamp TS2, the third time stamp TS3, and the fourth time stamp TS4. Information of each of time stamps TS is stored in a storage device of the signal processing device 30.

Further, the signal processing device 30 calculates a delay time (signal transmission delay) in each of the optical path 2A, the optical path 2B, and the optical path 2C on the basis of the first time stamp TS1, the second time stamp TS2, the third time stamp TS3, and the fourth time stamp TS4. Specifically, the delay time in the optical path 2A between the user terminal 10 and the optical node 20-1 is given by “TS2-TS1”. The delay time in the optical path 2B between the optical node 20-1 and the signal processing device 30 is given by “TS4-TS2”. The delay time in the optical path 2C between the user terminal 10 and the signal processing device 30 is given by “TS3-TS1”.

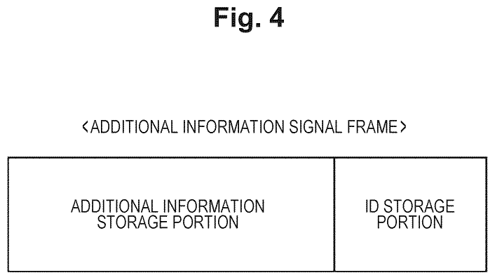

FIG. 4 is a conceptual diagram illustrating a frame configuration of an additional information signal AS. A frame of the additional information signal AS includes an additional information storage portion and an ID storage portion. The additional information storage portion stores additional information such as the time stamp TS. The ID storage portion stores identification information of a device (user terminal 10, optical node 20, and the like) to which the additional information is added. When the additional information is added, each device stores the additional information in the additional information storage portion, and stores its own identification information in the ID storage portion.

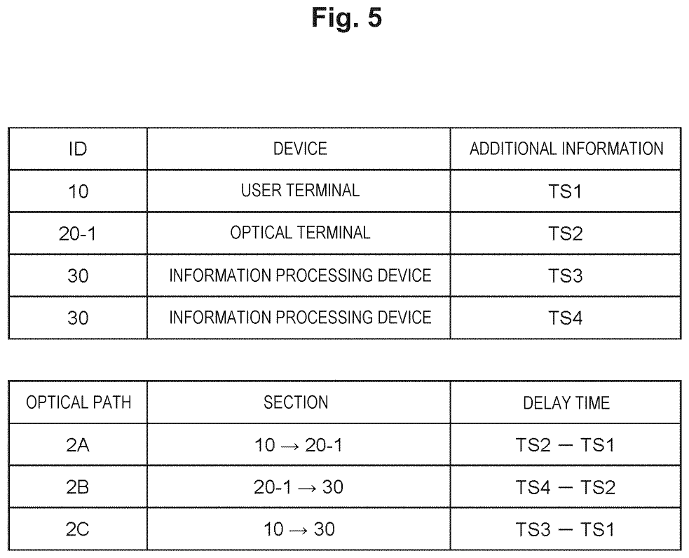

FIG. 5 is a conceptual diagram illustrating an example of delay measurement result information indicating a result of the delay measurement. The delay measurement result information indicates a correspondence relationship between identification information of a device and additional information added by the device. Further, the delay measurement result information indicates a correspondence relationship between an optical path (section) and a delay time. The signal processing device 30 generates such delay measurement result information and stores the delay measurement result information in the storage device. The delay measurement result information is sent to, for example, the network management device 50 and used for network quality management by the network management device 50.

### <Effects>

As described above, according to the present embodiment, the additional information signal AS having a carrier frequency different from that of the main optical signal MS is superimposed on the main optical signal MS. The additional information signal AS includes the time stamp TS reflecting a timing at which the additional information signal AS is generated. By using such a time stamp TS, it becomes possible to measure the delay time in the optical communication network 5.

The additional information signal AS including the time stamp TS is superimposed on the main optical signal MS and sent out to the optical path 2 together with the main optical signal MS. Unlike the case of the probe packets in the conventional technique, a special signal dedicated to delay measurement is not transmitted separately from the main optical signal MS. Thus, it becomes possible to suppress an increase in a transmission delay of the main optical signal MS and a decrease in a transmission capacity of the main optical signal MS.

In addition, the time stamp TS can be added without performing photoelectric conversion of the main optical signal MS. Thus, a processing delay associated with photoelectric conversion does not occur. Further, an increase in overhead associated with addition of the time stamp TS does not occur.

Note that the time stamp TS according to the present embodiment can also be referred to as an “optical time stamp”. According to the present embodiment, by using the optical time stamp, it becomes possible to suppress the increase in the transmission delay of the main optical signal MS and the decrease in the transmission capacity of the main optical signal MS.

Hereinafter, a detailed description will be given of each of delay measurement based on TDM and delay measurement based on FDM according to the present embodiment.

### 3. Delay Measurement Based on TDM

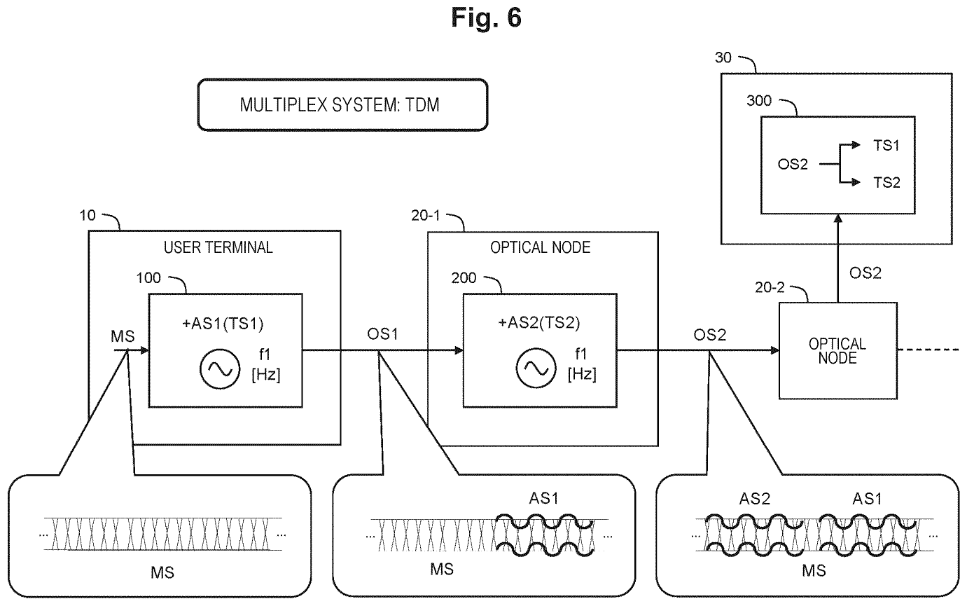

FIG. 6 is a block diagram schematically illustrating a configuration example related to the delay measurement based on TDM according to the present embodiment.

The user terminal 10 includes a controller 100. At the time of the delay measurement, the controller 100 generates the first additional information signal AS1. The first additional information signal AS1 includes the first time stamp TS1 reflecting the timing at which the first additional information signal AS1 is generated. A “first carrier frequency f1” that is the carrier frequency of the first additional information signal AS1 is sufficiently lower than the carrier frequency of the main optical signal MS. The controller 100 generates the first optical signal OS1 by superimposing the first additional information signal AS1 on the main optical signal MS. Then, the controller 100 outputs the generated first optical signal OS1 to the optical path 2A on the optical node 20-1 side.

The optical node 20-1 includes a controller 200. The controller 200 receives the first optical signal OS1 (input optical signal) input from the optical path 2A on the user terminal 10 side. In response, the controller 200 generates the second additional information signal AS2. The second additional information signal AS2 includes the second time stamp TS2 reflecting the timing at which the second additional information signal AS2 is generated. The carrier frequency of the second additional information signal AS2 is the “first carrier frequency f1” that is the same as the case of the first additional information signal AS1. The controller 200 generates the second optical signal OS2 by superimposing the second additional information signal AS2 on the main optical signal MS of the first optical signal OS1. At this time, as illustrated in FIG. 6, the controller 200 superimposes the second additional information signal AS2 on the main optical signal MS such that the second additional information signal AS2 does not overlap the first additional information signal AS1. Then, the controller 200 outputs the generated second optical signal OS2 (output optical signal) to the optical path 2B on the signal processing device 30 side.

The signal processing device 30 includes a controller 300. The controller 300 receives the second optical signal OS2 (output optical signal) output from the optical node 20-1 via the optical path 2B. The controller 300 extracts (separates) the first additional information signal AS1 and the second additional information signal AS2 from the second optical signal OS2 by using a filter. Further, the controller 300 acquires the first time stamp TS1 included in the first additional information signal AS1, and acquires the second time stamp TS2 included in the second additional information signal AS2.

In addition, the controller 300 acquires the third time stamp TS3 and the fourth time stamp TS4 (arrival time stamps) reflecting timings at which the first additional information signal AS1 and the second additional information signal AS2 respectively arrive at the controller 300. Then, the controller 300 calculates a delay time in each of the optical path 2A, the optical path 2B, and the optical path 2C on the basis of the first time stamp TS1, the second time stamp TS2, the third time stamp TS3, and the fourth time stamp TS4. The controller 300 stores the delay measurement result information (see FIG. 5) indicating information of the time stamps TS and information of delay times in the optical paths 2 in the storage device.

### 3-1. Configuration Example of User Terminal

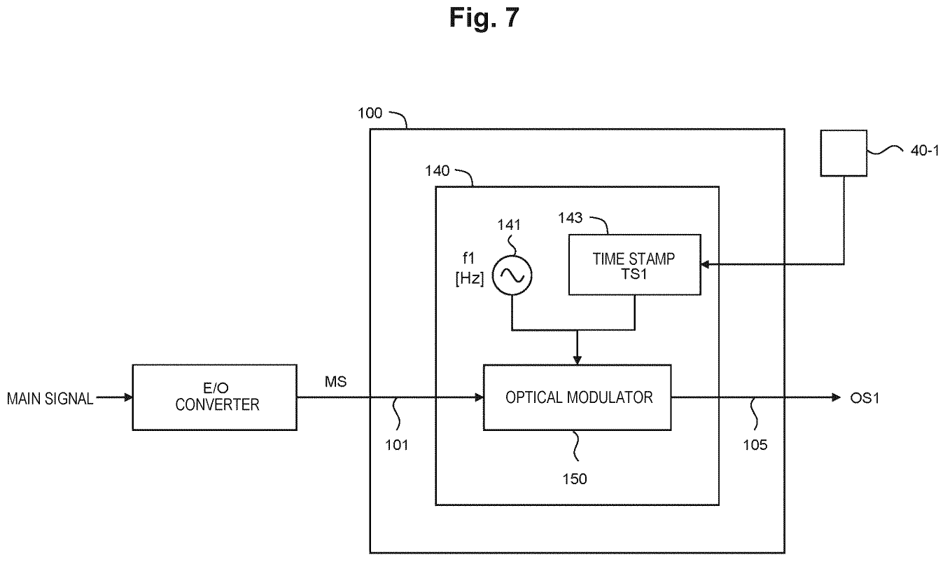

FIG. 7 is a block diagram illustrating a configuration example of the user terminal 10 related to the delay measurement. The user terminal 10 includes an E/O converter and the controller 100. The E/O converter converts a main signal (electrical signal) into the main optical signal MS. The controller 100 receives the main optical signal MS output from the E/O converter.

The controller 100 includes an additional information signal superimposing unit 140. At the time of the delay measurement, the additional information signal superimposing unit 140 generates the first additional information signal AS1, and superimposes the first additional information signal AS1 on the main optical signal MS. More specifically, the additional information signal superimposing unit 140 includes a carrier wave generator 141, a time stamp acquisition unit 143, and an optical modulator 150.

The carrier wave generator 141 generates a carrier wave of the first carrier frequency f1. The time stamp acquisition unit 143 acquires the time information from the high-precision clock 40-1 and acquires the first time stamp TS1. The time stamp acquisition unit 143 is implemented by, for example, a processor.

The optical modulator 150 receives the main optical signal MS output from the E/O converter via an optical path 101. In addition, the optical modulator 150 performs modulation on the basis of the carrier wave of the first carrier frequency f1 and the first time stamp TS1 to generate the first additional information signal AS1. Further, the optical modulator 150 generates the first optical signal OS1 by superimposing the first additional information signal AS1 on the main optical signal MS. Then, the optical modulator 150 outputs the generated first optical signal OS1 to the optical path 105.

Note that, the first time stamp TS1 is stored in the additional information storage portion of a frame (see FIG. 4) of the first additional information signal AS1. For example, identification information of the optical modulator 150 is stored in the ID storage portion of the frame of the first additional information signal AS1.

### 3-2. Configuration Example of Optical Node

### 3-2-1. First Configuration Example

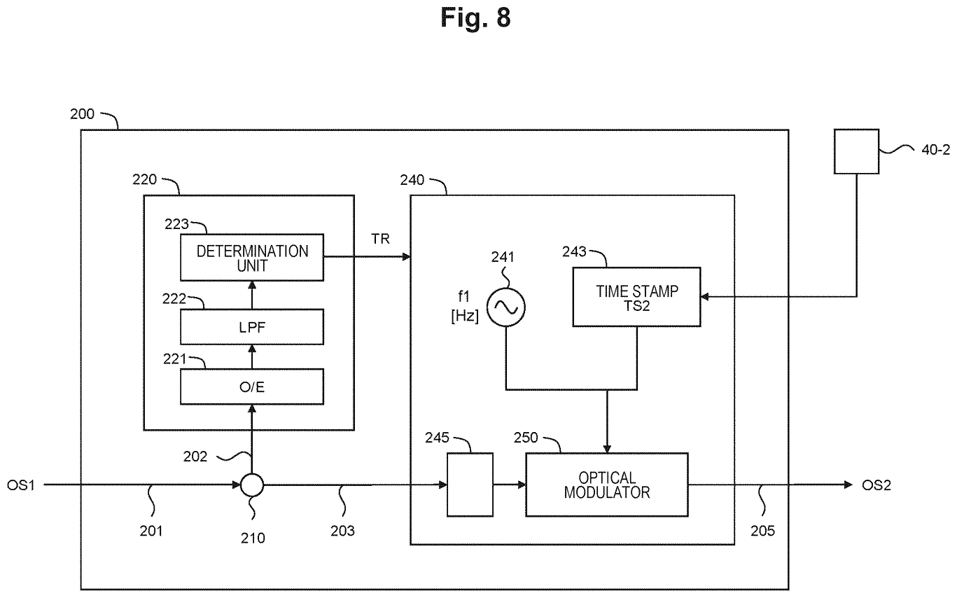

FIG. 8 is a block diagram illustrating a first configuration example of the optical node 20-1 related to the delay measurement based on TDM. The controller 200 of the optical node 20-1 includes an optical branching device 210, a trigger generating unit 220, and an additional information signal superimposing unit 240.

The first optical signal OS1 is input to the optical branching device 210 via an optical path 201. In addition, the optical branching device 210 is connected to the trigger generating unit 220 via an optical path 202, and is connected to the additional information signal superimposing unit 240 via an optical path 203. The optical branching device 210 causes the first optical signal OS1 (input optical signal) to branch and transfers the first optical signal OS1 to the trigger generating unit 220 and the additional information signal superimposing unit 240.

The trigger generating unit 220 generates a trigger for generating the second additional information signal AS2 at the time of the delay measurement. More specifically, the trigger generating unit 220 receives the input optical signal from the optical branching device 210. The trigger generating unit 220 determines whether or not the first additional information signal AS1 is included in the input optical signal. In a case where the first additional information signal AS1 is included in the input optical signal, the trigger generating unit 220 determines that the delay measurement is performed and generates a trigger signal TR. Then, the trigger generating unit 220 outputs the trigger signal TR to the additional information signal superimposing unit 240.

For example, the trigger generating unit 220 includes an O/E converter 221, a low-pass filter 222, and a determination unit 223. The input optical signal is input to the O/E converter 221 via the optical path 202. The O/E converter 221 converts the input optical signal into an electrical signal. The electrical signal is input to the determination unit 223 via the low-pass filter 222. The low-pass filter 222 is configured to transmit a signal in a frequency band less than or equal to a frequency in the vicinity of the first carrier frequency f1. The determination unit 223 receives the electrical signal output from the low-pass filter 222. The determination unit 223 determines whether or not there is the first additional information signal AS1 that is not noise on the basis of the electrical signal. In a case where there is the first additional information signal AS1, the determination unit 223 determines that the delay measurement is performed, and outputs the trigger signal TR to the additional information signal superimposing unit 240. The determination unit 223 is implemented by, for example, a processor.

As described above, the trigger generating unit 220 autonomously detects that the first additional information signal AS1 is included in the input optical signal. In other words, the trigger generating unit 220 autonomously detects that the delay measurement is performed. When detecting the first additional information signal AS1, the trigger generating unit 220 autonomously outputs the trigger signal TR. With the above configuration example, it becomes possible to prevent an erroneous trigger from being output due to noise caused by disturbance such as environmental change in the optical communication network 5.

In response to the trigger signal TR, the additional information signal superimposing unit 240 generates the second additional information signal AS2 and superimposes the second additional information signal AS2 on the main optical signal MS of the first optical signal OS1. More specifically, the additional information signal superimposing unit 240 includes a carrier wave generator 241, a time stamp acquisition unit 243, a signal delay unit 245, and an optical modulator 250.

The carrier wave generator 241 generates a carrier wave of the first carrier frequency f1. The time stamp acquisition unit 243 acquires the time information from the high-precision clock 40-2 and acquires the second time stamp TS2. The time stamp acquisition unit 243 is implemented by, for example, a processor.

The first optical signal OS1 is input to the signal delay unit 245 via the optical path 203. The signal delay unit 245 delays the first optical signal OS1 by buffering the first optical signal OS1 for a certain period of time. The certain period of time is set to be slightly shorter than a period of time from when the first optical signal OS1 is transferred from the optical branching device 210 to the optical path 202 to when the second additional information signal AS2 is generated in response to the trigger signal TR. The signal delay unit 245 is implemented by, for example, an optical fiber delay line.

The optical modulator 250 receives the first optical signal OS1 output from the signal delay unit 245. In addition, the optical modulator 250 performs modulation on the basis of the carrier wave of the first carrier frequency f1 and the second time stamp TS2 to generate a second additional information signal AS2. Further, the optical modulator 250 superimposes the second additional information signal AS2 on the main optical signal MS of the first optical signal OS1 to generate the second optical signal OS2. Since a slight time difference is given by the signal delay unit 245, the second additional information signal AS2 is superimposed on the main optical signal MS at a timing immediately after the first additional information signal AS1 superimposed on the main optical signal MS passes through the optical modulator 250 (see FIG. 6). That is, the second additional information signal AS2 is superimposed on the main optical signal MS such that the second additional information signal AS2 does not overlap the first additional information signal AS1. Then, the optical modulator 250 outputs the generated second optical signal OS2 to an optical path 205.

Note that, the second time stamp TS2 is stored in the additional information storage portion of a frame (see FIG. 4) of the second additional information signal AS2. For example, identification information of the optical modulator 250 is stored in the ID storage portion of the frame of the second additional information signal AS2.

### 3-2-2. Second Configuration Example

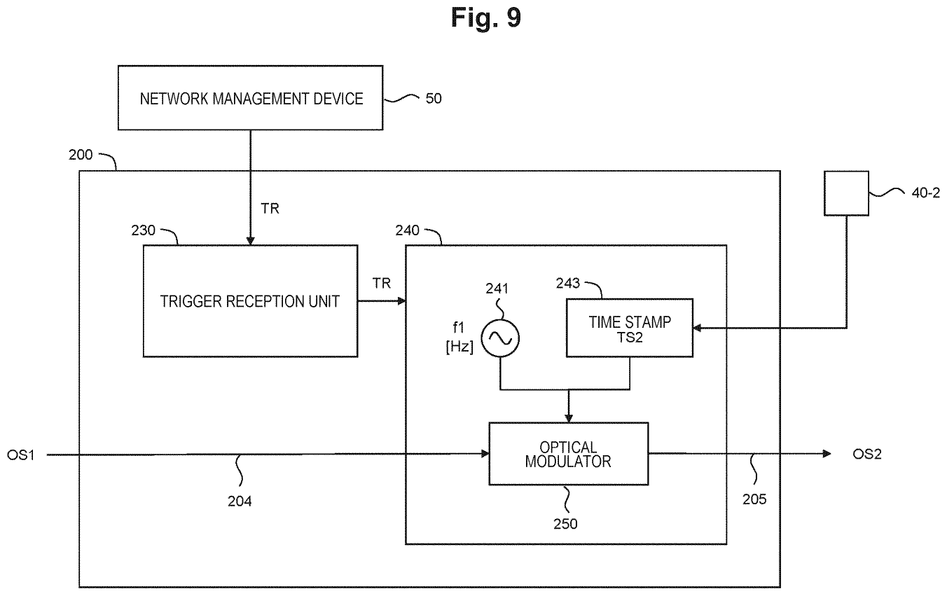

FIG. 9 is a block diagram illustrating a second configuration example of the optical node 20-1 related to the delay measurement based on TDM. The description overlapping with that of the first configuration example illustrated in FIG. 8 will be appropriately omitted. In the second configuration example, the controller 200 of the optical node 20-1 includes a trigger reception unit 230 and the additional information signal superimposing unit 240.

The trigger reception unit 230 communicates with the network management device 50 and receives the trigger signal TR from the network management device 50. The trigger reception unit 230 outputs the received trigger signal TR to the additional information signal superimposing unit 240.

The additional information signal superimposing unit 240 includes the carrier wave generator 241, the time stamp acquisition unit 243, and the optical modulator 250. The carrier wave generator 241 and the time stamp acquisition unit 243 are similar to those in the case of the first configuration example illustrated in FIG. 8. The optical modulator 250 receives the first optical signal OS1 via an optical path 204. The optical modulator 250 superimposes the second additional information signal AS2 on the main optical signal MS of the first optical signal OS1 to generate the second optical signal OS2. Then, the optical modulator 250 outputs the generated second optical signal OS2 to the optical path 205.

A delay time between the network management device 50 and the controller 200 is known. In addition, the network management device 50 grasps a delay measurement schedule in which the user terminal 10 transmits the first additional information signal AS1. The network management device 50 determines a sending timing of the trigger signal TR on the basis of the delay measurement schedule. More specifically, the network management device 50 transmits the trigger signal TR to the controller 200 at a timing at which the second additional information signal AS2 is superimposed immediately after the first additional information signal AS1 passes through the optical modulator 250. As a result, the second additional information signal AS2 is superimposed on the main optical signal MS at a timing immediately after the first additional information signal AS1 superimposed on the main optical signal MS passes through the optical modulator 250 (see FIG. 6). That is, the second additional information signal AS2 is superimposed on the main optical signal MS such that the second additional information signal AS2 does not overlap the first additional information signal AS1.

According to the second configuration example, it becomes possible to simplify the configuration of the controller 200 of the optical node 20-1. As a result, it becomes possible to reduce the cost of the optical node 20-1. In addition, since the optical branching device 210 is unnecessary, it becomes possible to avoid an increase in optical insertion loss. This is advantageous for extending a transmission distance and the like.

### 3-3. Configuration Example of Signal Processing Device

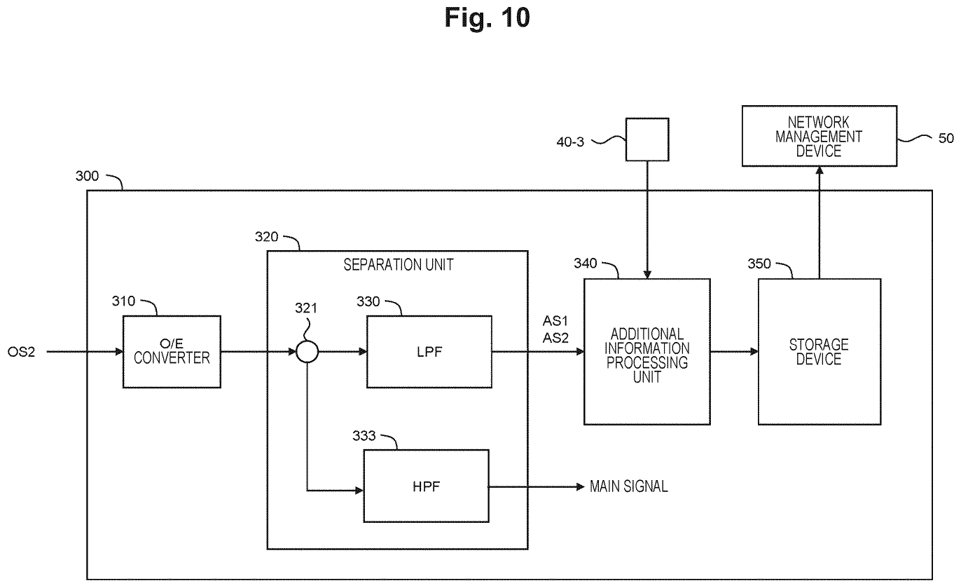

FIG. 10 is a block diagram illustrating a configuration example of the signal processing device 30 related to the delay measurement based on TDM. The controller 300 of the signal processing device 30 includes an O/E converter 310, a separation unit 320, an additional information processing unit 340, and a storage device 350.

The second optical signal OS2 output from the optical node 20-1 is input to the O/E converter 310. The O/E converter 310 converts the input second optical signal OS2 into an electrical signal and outputs the electrical signal to the separation unit 320.

The separation unit 320 receives the electrical signal corresponding to the second optical signal OS2. The separation unit 320 separates the electrical signal corresponding to the second optical signal OS2 into the first additional information signal AS1 (electrical signal), the second additional information signal AS2 (electrical signal), and the main signal.

More specifically, the separation unit 320 includes a branching device 321, a low-pass filter 330, and a high-pass filter 333. The branching device 321 causes the electrical signal corresponding to the second optical signal OS2 to branch and transfers the electrical signal to the low-pass filter 330 and the high-pass filter 333. The low-pass filter 330 is configured to transmit a signal in a frequency band less than or equal to a frequency in the vicinity of the first carrier frequency f1. The low-pass filter 330 extracts the first additional information signal AS1 (electrical signal) and the second additional information signal AS2 (electrical signal) from the electrical signal corresponding to the second optical signal OS2. The extracted first additional information signal AS1 and second additional information signal AS2 are output to the additional information processing unit 340. On the other hand, the high-pass filter 333 has a cutoff frequency band from a frequency of 0 to a frequency in the vicinity of the first carrier frequency f1. The high-pass filter 333 extracts the main signal (electrical signal) from the electrical signal corresponding to the second optical signal OS2. The extracted main signal is transferred to a main signal reception unit (not illustrated).

The additional information processing unit 340 demodulates the first additional information signal AS1 to acquire the first time stamp TS1. Similarly, the additional information processing unit 340 demodulates the second additional information signal AS2 to acquire the second time stamp TS2. In addition, the additional information processing unit 340 acquires the third time stamp TS3 (arrival time stamp) reflecting the timing at which the first additional information signal AS1 arrives. Similarly, the additional information processing unit 340 acquires the fourth time stamp TS4 (arrival time stamp) reflecting the timing at which the second additional information signal AS2 arrives. The third time stamp TS3 and the fourth time stamp TS4 are obtained on the basis of the time information acquired from the high-precision clock 40-3.

As described above, the additional information processing unit 340 acquires the first time stamp TS1, the second time stamp TS2, the third time stamp TS3, and the fourth time stamp TS4. Further, the additional information processing unit 340 calculates the delay time in each of the optical path 2A, the optical path 2B, and the optical path 2C on the basis of the first time stamp TS1, the second time stamp TS2, the third time stamp TS3, and the fourth time stamp TS4. Then, the additional information processing unit 340 stores the delay measurement result information (see FIG. 5) indicating the information of the time stamps TS and the information of the delay times in the optical paths 2 in the storage device 350.

The additional information processing unit 340 is implemented by, for example, a processor. Examples of the storage device 350 include a volatile memory, a nonvolatile memory, a hard disk drive (HDD), and a solid state drive (SSD).

The delay measurement result information stored in the storage device 350 may be sent to the network management device 50. For example, the network management device 50 performs network quality management on the basis of the delay measurement result information.

### 3-4. Effects

As described above, according to the present embodiment, the additional information signal AS having a carrier frequency different from that of the main optical signal MS is superimposed on the main optical signal MS. The additional information signal AS includes the time stamp TS reflecting a timing at which the additional information signal AS is generated. By using such a time stamp TS, it becomes possible to measure the delay time in the optical communication network 5.

The additional information signal AS including the time stamp TS is superimposed on the main optical signal MS and sent out together with the main optical signal MS. Unlike the case of the probe packets in the conventional technique, a special signal dedicated to delay measurement is not transmitted separately from the main optical signal MS. Thus, it becomes possible to suppress an increase in a transmission delay of the main optical signal MS and a decrease in a transmission capacity of the main optical signal MS.

In addition, the time stamp TS can be added without performing photoelectric conversion of the main optical signal MS. Thus, a processing delay associated with photoelectric conversion does not occur. Further, an increase in overhead associated with addition of the time stamp TS does not occur.

Further, the first additional information signal AS1 and the second additional information signal AS2 having the same first carrier frequency f1 can be subjected to time division multiplexing to avoid signal interference. It becomes possible for the signal processing device 30 to reliably demodulate the first time stamp TS1 and the second time stamp TS2 from the first additional information signal AS1 and the second additional information signal AS2, respectively.

In addition, since it is not necessary to generate different carrier frequencies, it is not necessary to prepare a plurality of types of carrier wave generators. Thus, the configuration of the optical node 20 is simplified. Further, the configuration of the separation unit 320 of the signal processing device 30 is also simplified. These contribute to reduce the cost of each device.

### 4. Delay Measurement Based on FDM

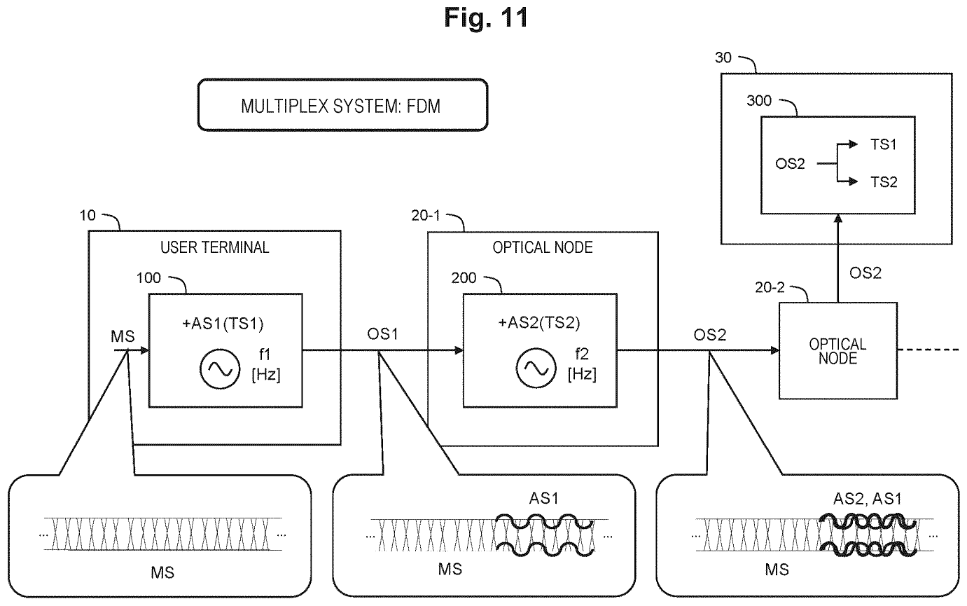

FIG. 11 is a block diagram schematically illustrating a configuration example related to the delay measurement based on FDM according to the present embodiment. The description overlapping with the case of TDM described above will be appropriately omitted.

The user terminal 10 includes the controller 100. The controller 100 is similar to the case of TDM described above.

The optical node 20-1 includes the controller 200. The controller 200 receives the first optical signal OS1 (input optical signal) input from the optical path 2A on the user terminal 10 side. In response, the controller 200 generates the second additional information signal AS2. The carrier frequency of the second additional information signal AS2 is a “second carrier frequency f2” different from the first carrier frequency f1 of the first additional information signal AS1. The controller 200 generates the second optical signal OS2 by superimposing the second additional information signal AS2 on the main optical signal MS of the first optical signal OS1. At this time, as illustrated in FIG. 11, the controller 200 may superimpose the second additional information signal AS2 on the main optical signal MS such that the second additional information signal AS2 and the first additional information signal AS1 at least partially overlap each other. Then, the controller 200 outputs the generated second optical signal OS2 (output optical signal) to the optical path 2B on the signal processing device 30 side.

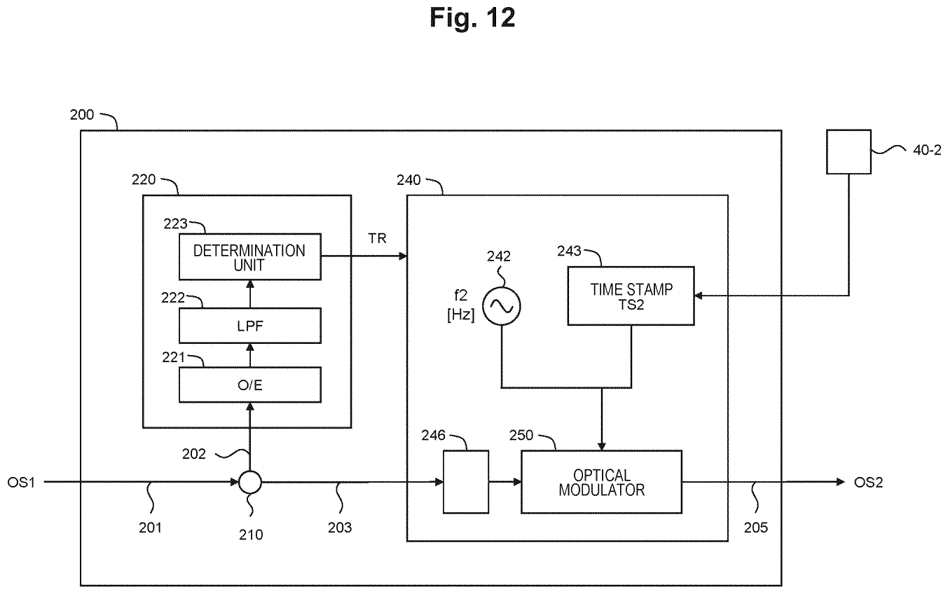

FIG. 12 is a block diagram illustrating a first configuration example of the optical node 20-1 related to the delay measurement based on FDM. The controller 200 of the optical node 20-1 includes the optical branching device 210, the trigger generating unit 220, and the additional information signal superimposing unit 240. The optical branching device 210 and the trigger generating unit 220 are similar to those in the case of TDM illustrated in FIG. 8.

The additional information signal superimposing unit 240 includes a carrier wave generator 242, the time stamp acquisition unit 243, a signal delay unit 246, and the optical modulator 250. The carrier wave generator 242 generates a carrier wave of the second carrier frequency f2. The signal delay unit 246 delays the first optical signal OS1 by buffering the first optical signal OS1 for a certain period of time. The certain period of time is set to be about the same as the period of time from when the first optical signal OS1 is transferred from the optical branching device 210 to the optical path 202 to when the second additional information signal AS2 is generated in response to the trigger signal TR. Thus, the second additional information signal AS2 is superimposed on the main optical signal MS at substantially the same timing as a timing at which the first additional information signal AS1 superimposed on the main optical signal MS passes through the optical modulator 250 (see FIG. 11). That is, the second additional information signal AS2 is superimposed on the main optical signal MS such that the second additional information signal AS2 and the first additional information signal AS1 at least partially overlap each other.

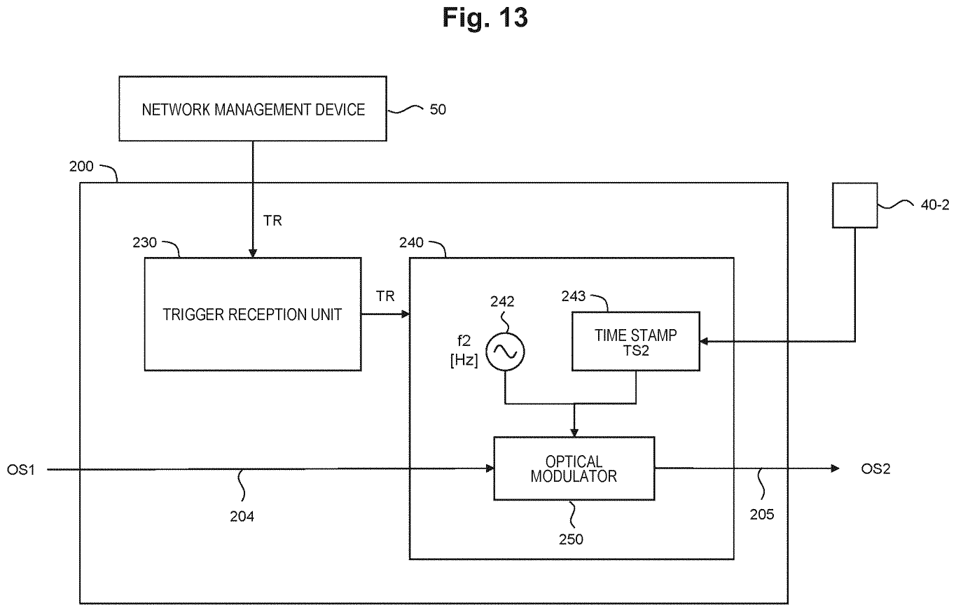

FIG. 13 is a block diagram illustrating a second configuration example of the optical node 20-1 related to the delay measurement based on FDM. The controller 200 of the optical node 20-1 includes the trigger reception unit 230 and the additional information signal superimposing unit 240. The trigger reception unit 230 is similar to the case of TDM illustrated in FIG. 9.

The additional information signal superimposing unit 240 includes the carrier wave generator 242, the time stamp acquisition unit 243, and the optical modulator 250. The carrier wave generator 242 generates the carrier wave of the second carrier frequency f2. Others are similar to the case of TDM illustrated in FIG. 9.

A delay time between the network management device 50 and the controller 200 is known. In addition, the network management device 50 grasps a delay measurement schedule in which the user terminal 10 transmits the first additional information signal AS1. The network management device 50 determines a sending timing of the trigger signal TR on the basis of the delay measurement schedule. More specifically, the network management device 50 transmits the trigger signal TR to the controller 200 at a timing at which the second additional information signal AS2 is superimposed at the timing at which the first additional information signal AS1 passes through the optical modulator 250. As a result, the second additional information signal AS2 is superimposed on the main optical signal MS at the timing at which the first additional information signal AS1 superimposed on the main optical signal MS passes through the optical modulator 250 (see FIG. 11). That is, the second additional information signal AS2 is superimposed on the main optical signal MS such that the second additional information signal AS2 and the first additional information signal AS1 at least partially overlap each other.

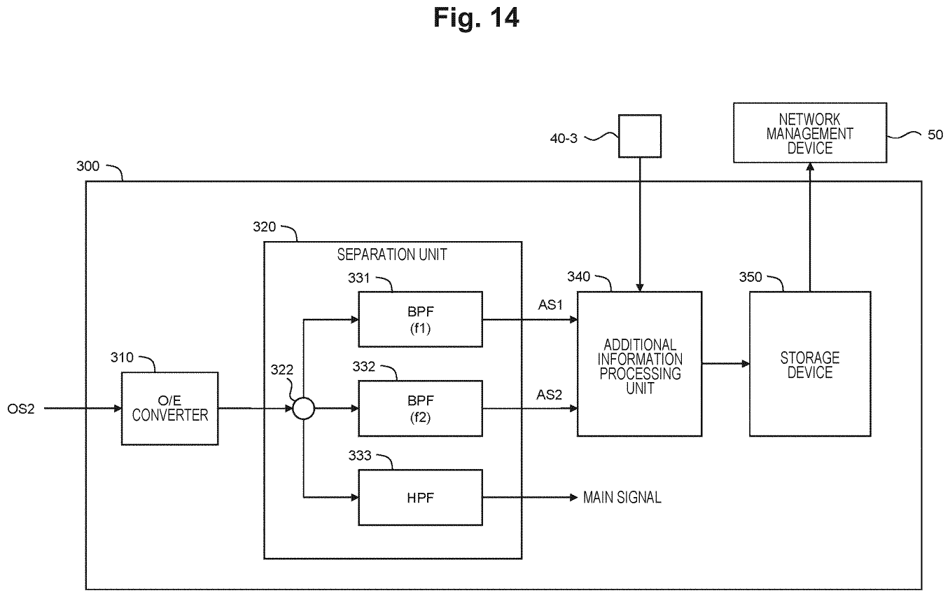

FIG. 14 is a block diagram illustrating a configuration example of the signal processing device 30 related to the delay measurement based on FDM. The controller 300 of the signal processing device 30 includes the O/E converter 310, the separation unit 320, the additional information processing unit 340, and the storage device 350. The O/E converter 310, the additional information processing unit 340, and the storage device 350 are similar to those of the case of TDM illustrated in FIG. 10.

The separation unit 320 includes a branching device 322, a first band-pass filter 331, a second band-pass filter 332, and the high-pass filter 333. The branching device 322 causes the electrical signal corresponding to the second optical signal OS2 to branch and transfers the electrical signal to the first band-pass filter 331, the second band-pass filter 332, and the high-pass filter 333. The first band-pass filter 331 is configured to transmit a signal in a frequency band in the vicinity of the first carrier frequency f1. The first band-pass filter 331 extracts the first additional information signal AS1 (electrical signal) from the electrical signal corresponding to the second optical signal OS2. On the other hand, the second band-pass filter 332 is configured to transmit a signal in a frequency band in the vicinity of the second carrier frequency f2. The second band-pass filter 332 extracts the second additional information signal AS2 (electrical signal) from the electrical signal corresponding to the second optical signal OS2. The extracted first additional information signal AS1 and second additional information signal AS2 are output to the additional information processing unit 340.

As described above, the first additional information signal AS1 having the first carrier frequency f1 and the second additional information signal AS2 having the second carrier frequency f2 can be subjected to frequency division multiplexing to avoid signal interference. It becomes possible for the signal processing device 30 to reliably demodulate the first time stamp TS1 and the second time stamp TS2 from the first additional information signal AS1 and the second additional information signal AS2, respectively.

### REFERENCE SIGNS LIST

1 optical communication system
2 optical path
5 optical communication network
10 user terminal
20 optical node
30 signal processing device
40 high-precision clock
50 network management device
100 controller
101, 105 optical path
140 additional information signal superimposing unit
141 carrier wave generator
143 time stamp acquisition unit
150 optical modulator
200 controller
201, 202, 203, 204, 205 optical path
210 optical branching device
220 trigger generating unit
221 O/E converter
222 low-pass filter
223 determination unit
230 trigger reception unit
240 additional information signal superimposing unit
241, 242 carrier wave generator
243 time stamp acquisition unit
245, 246 signal delay unit
250 optical modulator
300 controller
310 O/E converter
320 separation unit
321, 322 branching device
330 low-pass filter
331 first band-pass filter
332 second band-pass filter
333 high-pass filter
340 additional information processing unit
350 storage device
f1 first carrier frequency
f2 second carrier frequency
AS additional information signal
AS1 first additional information signal
AS2 second additional information signal
MS main optical signal
OS1 first optical signal
OS2 second optical signal
TR trigger signal
TS time stamp
TS1 first time stamp
TS2 second time stamp

1. An optical communication device connected to an optical path in an optical communication network,
the optical communication device comprising a controller and a memory, wherein:
the controller is configured using instructions stored in the memory, to:
generate an additional information signal having a carrier frequency different from a carrier frequency of a main optical signal;
generate an output optical signal by superimposing the additional information signal on the main optical signal; and
output the output optical signal to the optical path, and
the additional information signal includes a time stamp reflecting a timing at which the additional information signal is generated.

2. The optical communication device according to claim 1, wherein:
the optical communication device is an optical node provided on the optical path between a transmission device and a reception device in the optical communication network, and
in the transmission device, a first additional information signal including a first time stamp is superimposed on the main optical signal, and
the controller is configured to:
receive an input optical signal input from the optical path on the transmission device's side;
generate, as the additional information signal, a second additional information signal including a second time stamp as the time stamp;
generate the output optical signal by superimposing the second additional information signal on the main optical signal of the input optical signal; and
output the output optical signal to the optical path on the reception device's side.

3. The optical communication device according to claim 2, wherein:
the carrier frequency of the first additional information signal and the carrier frequency of the second additional information signal are equal to each other, and
the controller is configured to superimpose the second additional information signal on the main optical signal such that the second additional information signal does not overlap the first additional information signal.

4. The optical communication device according to claim 2, wherein:
the carrier frequency of the first additional information signal is a first carrier frequency, and
the carrier frequency of the second additional information signal is a second carrier frequency different from the first carrier frequency.

5. The optical communication device according to claim 2, wherein the controller is further configured to:
determine whether or not the first additional information signal is included in the input optical signal;
generate a trigger signal in a case where the first additional information signal is included in the input optical signal; and
generate the second additional information signal in response to the trigger signal.

6. The optical communication device according to claim 2, wherein the controller is further configured to:
receive a trigger signal from a network management device that controls the optical communication device; and
generate the second additional information signal in response to the trigger signal.

7. A signal processing device connected to optical communication circuitry via an optical path in an optical communication network, wherein:
the optical communication circuitry is configured to:
generate an additional information signal having a carrier frequency different from a carrier frequency of a main optical signal; generate an output optical signal by superimposing the additional information signal on the main optical signal; and
output the output optical signal to the optical path, and
the additional information signal includes a time stamp reflecting a timing at which the additional information signal is generated,
the signal processing device comprising a controller and memory, wherein:
the controller is configured using instructions stored in the memory, to:
receive the output optical signal output from the optical communication device via the optical path;
extract the additional information signal from the output optical signal received; and
store, in a memory, the time stamp included in the additional information signal and an arrival time stamp reflecting a timing at which the additional information signal arrives at the signal processing device.

8. An optical communication method, comprising:
generating an additional information signal having a carrier frequency different from a carrier frequency of a main optical signal;
generating an output optical signal by superimposing the additional information signal on the main optical signal; and
outputting the output optical signal to the optical path,
wherein the additional information signal includes a time stamp reflecting a timing at which the additional information signal is generated.

9. (canceled)
